(19) United States
(12) Patent Application Publication
(10) Pub. No.: US 2012/0212961 A1
(43) Pub. Date: Aug. 23, 2012

(54) LIGHT EMITTING DIODE STRING LAMP APPARATUS

(76) Inventor: Zi-Hui LIU, Guangzhou City (CN)

(21) Appl. No.: 13/032,156

(22) Filed: Feb. 22, 2011

(51) Int. Cl. F21S 4/00

(52) U.S. Cl. 362/249.06

(57) ABSTRACT

The present invention discloses an LED string lamp apparatus which includes plural LEDs serving as a light source, wherein any two neighboring LEDs are connected together through a lead wire. In addition, plural insulation sheaths, a quantity of which matches with that of the LEDs, are used to support the LEDs; whereas, plural floor plugs, a quantity of which matches with that of the LEDs, are used to fix the LED string lamp. Additionally, an LED assembly, which is formed by the insulation sheath and the LED, can be movably installed on the floor plug. The LED string lamp provided by the present invention can be hung on tree branches or a fence and can be fixed on a ground or a lawn, which expands the area of application.

### BACKGROUND OF THE INVENTION

a) Field of the Invention

The present invention relates to an ordinary ornamental lighting instrument, and more particularly to an LED (Light Emitting Diode) string lamp apparatus.

b) Description of the Prior Art

LED string lamps are being more and more widely used in ornamental lighting. An existing LED string lamp is constituted by LEDs, connection wires and insulation sheaths. When used, the string lamp is normally wound on tree branches, hung on a fence or a place on a building with support, and is not able to be fixed on a soil ground or a lawn; therefore, a scope of application is limited.

Accordingly, it is necessary to provide an LED string lamp apparatus which can be wound on tree branches or a fence and is easily fixed on a ground or a lawn.

### SUMMARY OF THE INVENTION

The primary object of the present invention is to provide an LED string lamp apparatus which is able to be wound on tree branches or a fence, and is easily fixed on a ground or a lawn.

To realize the abovementioned object, an LED string lamp apparatus provided by the present invention includes plural LEDs serving as a light source, wherein any two neighboring abovementioned LEDs are connected through a lead wire. The present invention is characterized in that plural insulation sheaths, a quantity of which matches with that of the LEDs, are used to support the LEDs; whereas, plural floor plugs, a quantity of which matches with that of the LEDs, are used to fix the LED string lamp. In addition, an LED assembly, which is formed by the insulation sheath and the LED, can be movably installed on the floor plug.

Furthermore, the LED includes an illuminator and two pins of different polarities at a same side of the illuminator. The floor plug includes an upper portion and a lower portion which is used for fixing. The upper portion of the floor plug is provided with an installation space and a wall of the upper portion of the floor plug is provided with an opening. The two abovementioned pins are provided in the insulation sheath and the insulation sheath is installed in the installation space of the upper portion of the floor plug. The illuminator is exposed out of the insulation sheath and an end part of the upper portion of the floor plug. Any two neighboring pins of a same polarity in the abovementioned LEDs are connected together through the lead wire which passes through a lower part of the opening.

Furthermore, an end of the lower portion of the floor plug, opposite to the upper portion of the floor plug, is a tip used for fixing.

Furthermore, the entire lower portion of the floor plug is gradually thinner from the end which connects the upper portion of the floor plug to the tip.

Furthermore, the floor plug is formed integrally.

The present invention provides an LED string lamp apparatus, wherein the LED assembly is formed by installing the LED in the insulation sheath and can be movably installed on the floor plug, meaning that the LED assembly can be installed on the floor plug to be inserted on a ground or a lawn. On the other hand, the LED assembly can be also taken down from the floor plug according to various needs, to serve as a normal LED string lamp that is hung on tree branches or a fence for decoration. Therefore, the LED string lamp provided by the present invention can realize the function of being hung on a fence or tree branches and can be fixed on a ground or a lawn, thereby achieving the effect of multifunctional decoration and expanding the area of application.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of an LED string lamp apparatus provided by the present invention.

FIG. 2 shows a schematic view of FIG. 1, with that a single LED, a single insulation sheath and a single floor plug are fitted together.

FIG. 3 shows an exploded view of the single LED, the single insulation sheath and the single floor plug in FIG. 2.

### DETAILED DESCRIPTION OF THE PREFERRED EMBODIMENTS

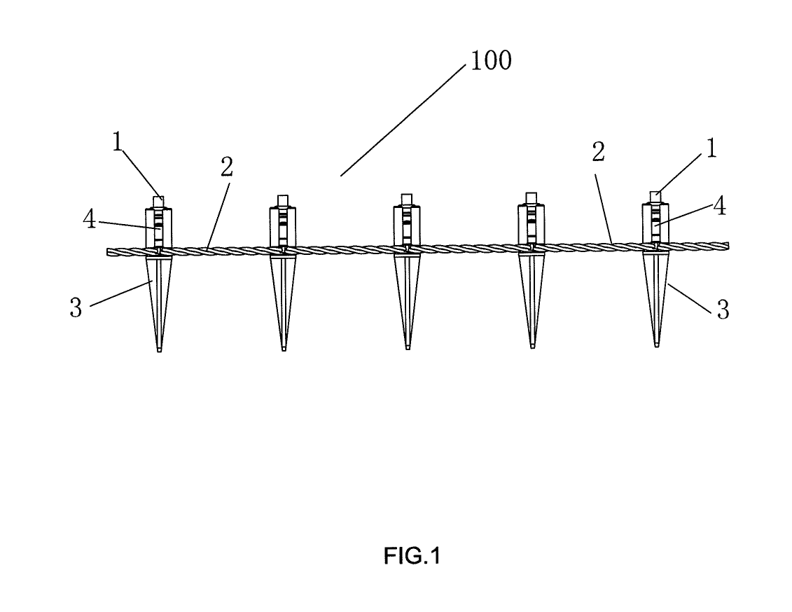

Referring to FIG. 1, an LED string lamp apparatus 100 provided by the present invention comprises plural LEDs 1 as a light source, wherein any two neighboring LEDs 1 are connected together through a lead wire 2, plural insulation sheaths 4, a quantity of which matches with that of the LEDs 1, are used to support the LEDs 1, and plural floor plugs 3, a quantity of which matches with that of the LEDs 1, are used to fix the LED string lamp apparatus 100; whereas, an LED assembly which is constituted by the insulation sheath 4 and the LED 1 can be movably installed on the floor plug 3. As the floor plugs 3 can be used to fix the LED string lamp apparatus 100 on a ground or a lawn, the LED assemblies can be installed on the floor plugs 3 and then the floor plugs 3 are inserted on the ground or the lawn for ornamental lighting, as required. On the other hand, the LED assemblies can be also taken down from the floor plugs 3 as demanded to serve individually as a normal LED string lamp that is hung on tree branches or a fence for ornamental lighting. Therefore, through movably installing the LED assemblies on the floor plugs 3, various decoration effects can be realized at different situations according to different needs, thereby expanding the area of application.

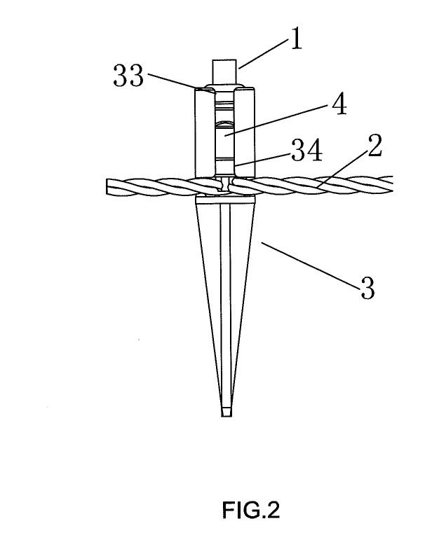

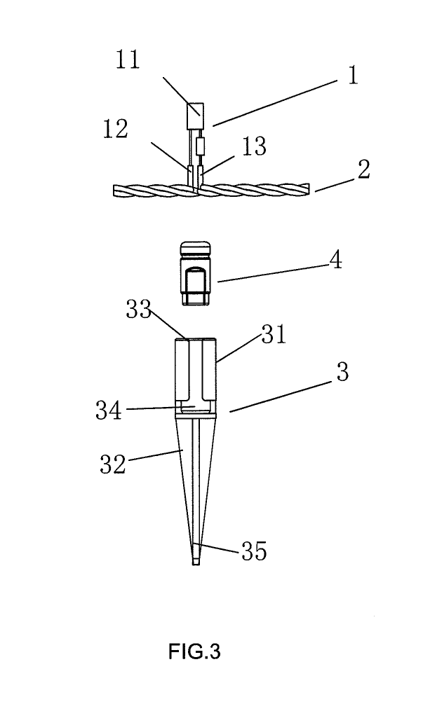

Referring to FIG. 2 and FIG. 3, the LED 1 includes an illuminator 11 and two pins 12, 13 of different polarities at a same side of the illuminator 11. The abovementioned floor plug 3 includes an upper portion 31 and a lower portion 32 which is used for fixing, wherein the upper portion 31 is provided with a hollow installation space 33 to install the insulation sheath 4. A wall of the upper portion 31 is provided with an opening 34 to connect the abovementioned installation space 33. The two abovementioned pins 12, 13 are provided in the insulation sheath 4 which is installed in the installation space 33 of the upper portion 31. The illuminator 11 is exposed out of the insulation sheath 4 and an end part of the upper portion 31 for outward ornamental lighting. In the abovementioned plural LEDs 1, any two neighboring pins 12 of a same polarity and two neighboring pins 13 of a same polarity are connected together through the lead wire 2 which passes through a lower part of the opening 34. The pins of the LED 1 and the lead wire 2 are connected together through welding or tightly fastening with a metal strip.

By providing the abovementioned opening 34, the insulation sheath 4 or the LED assembly can be conveniently installed in the installation space 33 of the floor plug 3 or taken out of the installation space 33. Therefore, the insulation sheath 4 and the LED 1 can constitute an LED assembly which can be freely taken down from the installation space 33 or can be installed in the installation space 33 as demanded. The LED string lamp apparatus 100 can be fixed on the ground or the lawn through the floor plugs 3 to realize ornamental lighting.

The pins 12, 13 are enclosed by the insulation sheath 4 with injection molding or a sleeve that the pins 12, 13 can be isolated from ambient and dust or rain can be prevented from entering into the LED 1 to damage the LED 1. The pins 12, 13 and the lead wire 2 are connected together by soldering or other methods. The floor plugs 3 are fixed below the LED assemblies through latching, inserting, sheathing or other methods, such that the LED assemblies can be inserted on the ground or the lawn very easily.

An end of the lower portion 32 of the floor plug 3 opposite to the upper portion 31 is a tip 35 which is used for fixing. The provision of the tip 35 facilitates inserting the floor plug 3 into the ground or the lawn to realize fixing. It is preferably that the entire lower portion 32 of the floor plug 3 is gradually thinner from the end which connects the upper portion 31 to the tip 35, finally forming the tip 35. This gradual change can facilitate inserting the floor plug 3 and is also pretty. The floor plug 3 is formed integrally; additionally, the upper portion 31 and the lower portion 32 are formed integrally through processing.

For the LED string lamp apparatus 100 provided by the present invention, each LED 1 is installed on one floor plug 3 and each floor plug 3 is independent. Through the insulation sheath 4, the pins 12, 13 are enclosed in the upper portion 31 of the floor plug 3 and therefore are insulated. Besides, the pins 12, 13 are isolated from ambient for protection. An LED assembly is constituted by the insulation sheath 4 and the LED 1 and can be freely installed in or taken down from the installation space 33 of the upper portion 31. When the LED assembly is installed in the installation space 33 as required, the illuminator 11 is exposed out of the insulation sheath 4 and the end surface of the upper portion 31 of the floor plug 3 to be used for ornamental lighting. For the plural LEDs 1, the pins 12 of the same polarity and the pins 13 of the same polarity are connected together through the lead wire 2 which is connected to a control power source to control illumination of the LEDs 1. As the floor plug 3 is provided with the tip 35, the tip 35 can be inserted into the ground, the lawn or a vase very conveniently. Therefore, the LED string lamp apparatus 100 can be fixed at various locations of need and can be fixed on the lawn or a soil ground very conveniently, thereby expanding the area of application of the LED string lamp. On the other hand, according to different needs, the abovementioned LED assemblies can be also taken down from the floor plugs 3 to be used as a normal LED string lamp for ornamental lighting. Therefore, the LED string lamp apparatus 100 provided by the present invention can realize ornamental lighting at various situations as required, thereby expanding the area of application.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A light emitting diode string lamp apparatus comprising plural LEDs (Light Emitting Diode) serving as a light source, wherein any two neighboring LEDs are connected together through a lead wire, plural insulation sheaths, a quantity of which matches with that of the LEDs, are used to support the LEDs, plural floor plugs, a quantity of which matches with that of the LEDs, are used to fix the LED string lamp, and an LED assembly which is constituted by the insulation sheath and the LED is movably installed on the floor plug.

2. The light emitting diode string lamp apparatus according to claim 1, wherein the LED includes an illuminator and two pins of different polarities at a same side of the illuminator, the floor plug includes an upper portion and a lower portion which is used for fixing, the upper portion of the floor plug is provided with a hollow installation space, a wall of the upper portion of the floor plug is provided with an opening which connects the installation space, the two pins are provided in the insulation sheath, the insulation sheath is movably installed in the installation space of the upper portion of the floor plug, the illuminator is exposed out of the insulation sheath and an end part of the upper portion of the floor plug, and any two neighboring pins of a same polarity in the plural LEDs are connected together through the lead wire which passes through a lower part of the opening.

3. The light emitting diode string lamp apparatus according to claim 2, wherein an end of the lower portion of the floor plug opposite to the upper portion of the floor plug is a tip which is used for fixing.

4. The light emitting diode string lamp apparatus according to claim 3, wherein the entire lower portion of the floor plug is gradually thinner from the end which connects the upper portion of the floor plug to the tip.

5. The light emitting diode string lamp apparatus according to claim 4, wherein the floor plug is formed integrally.
